(19) United States
(12) Patent Application Publication
(10) Pub. No.: US 2025/0190323 A1
(43) Pub. Date: Jun. 12, 2025

(54) Digital Green Score: AI-Driven Environmental Impact Assessment for Digital Content Usage

(71) Applicants: Durga Rao Manchikanti, South Jordan, UT (US); Nishanth Vepachedu, Holladay, UT (US); Hanumantha Rao Kavuri, Herriman, UT (US); Srujan Reddy Anugu, Mason, OH (US)

(72) Inventors: Durga Rao Manchikanti, South Jordan, UT (US); Nishanth Vepachedu, Holladay, UT (US); Hanumantha Rao Kavuri, Herriman, UT (US); Srujan Reddy Anugu, Mason, OH (US)

(21) Appl. No.: 19/060,835

(22) Filed: Feb. 24, 2025

(51) Int. Cl. G06F 11/34

(52) U.S. Cl. CPC G06F 11/3447

(57) ABSTRACT

The present invention relates to a Digital Green Score (DGS) system and a framework that evaluates the environmental impact of digital content usage, infrastructure management, and resource consumption. The DGS is generated at the individual level, aggregating scores across all applications and systems the person is responsible for. The organization-wide DGS is an aggregation of all individual scores, ensuring comprehensive sustainability management. The present invention aims to establish a global standard for measuring digital sustainability and ensuring a responsible, eco-friendly future for digital ecosystems.

### TECHNICAL FIELD

The present invention relates to the field of environmental sustainability in digital ecosystems, and more specifically, to a system and method for calculating a Digital Green Score (DGS) that quantifies the environmental impact of digital content usage at both the individual and organizational levels using artificial intelligence (AI) and blockchain technologies.

### BACKGROUND OF THE INVENTION

The exponential growth of digital content and services has led to significant environmental impacts, including excessive energy consumption in data centers, inefficient storage utilization, and unnecessary computational resource allocation. While sustainability efforts have traditionally focused on hardware and infrastructure, there is a lack of a standardized approach to assess and optimize the environmental footprint of digital content consumption, application usage, and cloud computing operations.

The need for a Digital Green Score (DGS) arises to address these challenges by providing a quantifiable measure of digital sustainability, encouraging responsible digital practices, and ensuring transparency in resource usage across individuals and organizations.

### BRIEF SUMMARY OF THE INVENTION

An object of the present invention is to establish a global standard for measuring digital sustainability and ensuring a responsible, eco-friendly future for digital ecosystems.

This invention introduces a Digital Green Score (DGS) system, a framework that evaluates the environmental impact of digital content usage, infrastructure management, and resource consumption. The DGS is generated at the individual level, aggregating scores across all applications and systems the person is responsible for. The organization-wide DGS is an aggregation of all individual scores, ensuring comprehensive sustainability management.

Key features of the present invention include:
i) AI-Powered Analysis: AI models analyze digital activities such as email cleanup, cloud resource optimization, and device efficiency to assign an individual DGS.
ii) Blockchain-Based Transparency: A decentralized ledger records DGS scores, ensuring auditability, trust, and compliance with ESG (Environmental, Social, and Governance) reporting.
iii) Decentralized & Automated Enforcement: Smart contracts enforce digital sustainability policies, rewarding responsible behavior and preventing unnecessary resource consumption.
iv) Scalable Application: The system works at both individual and organizational levels, ensuring that digital resources are managed effectively across enterprises.

### BRIEF DESCRIPTION OF THE DRAWINGS

Other objects and advantages of the present invention will become apparent to those skilled in the art upon reading the following detailed description of the preferred embodiments, in conjunction with the accompanying drawings, wherein like reference numerals have been used to designate like elements, and wherein:

FIG. 1 illustrates flow chart for calculating digital green score (DGS) according to one embodiment of the invention.

The drawings described herein are for illustration purposes only and are not intended to limit the scope of the present invention in any way.

### DETAILED DESCRIPTION OF THE INVENTION

It is to be understood that the present disclosure is not limited in its application to the details of construction and the arrangement of components set forth in the following description or illustrated in the drawings. The present disclosure is capable of other embodiments and of being practiced or of being carried out in various ways. In addition, it is to be understood that the phraseology and terminology used herein is for the purpose of description and should not be regarded as limiting.

The use of “including”, “comprising” or “having” and variations thereof herein is meant to encompass the items listed thereafter and equivalents thereof as well as additional items. The terms “a” and “an” herein do not denote a limitation of quantity, but rather denote the presence of at least one of the referenced items. Further, the use of terms “first”, “second”, and “third”, and the like, herein do not denote any order, quantity, or importance, but rather are used to distinguish one element from another.

According to one embodiment of the invention, a system and method for calculating a Digital Green Score (DGS) that quantifies the environmental impact of digital content usage at both the individual and organizational levels using artificial intelligence (AI) and blockchain technologies is disclosed. The system utilizes AI models to analyze an individual's email management, cloud resource allocation, storage optimization, and compute efficiency to generate a personalized sustainability score. Further, a blockchain-based DGS ledger ensures transparent tracking and auditability of individual and organizational digital sustainability metrics.

According to one embodiment of the invention, the system includes a smart contract-based enforcement mechanism that automatically implements sustainability policies and rewards responsible digital behaviour. In addition, the system includes a framework for aggregating individual DGS scores at an organizational level to measure overall corporate digital sustainability performance.

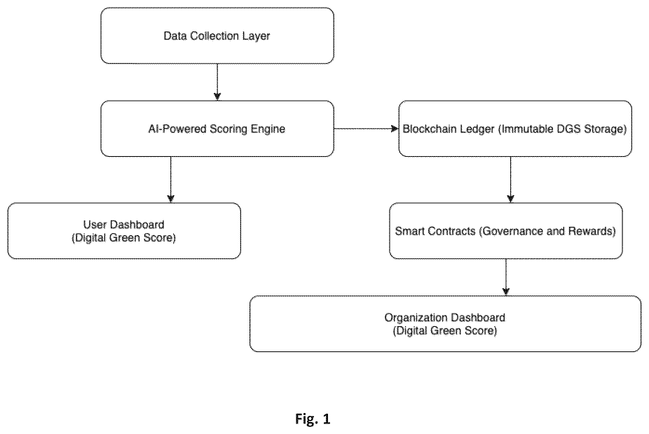

FIG. 1 illustrates flow chart for calculating digital green score (DGS) according to one embodiment of the invention. The Implementation Architecture consists of:
1. Data Collection Agents: APIs that track individual and enterprise-level digital activities.
2. AI Engine: Machine learning models analyze data and compute DGS scores.
3. Blockchain Layer: Stores all DGS calculations and updates immutably.
4. User Dashboard: Displays real-time DGS, recommendations, and compliance status.
5. Regulatory Interface: Enables enterprises to share verified sustainability reports.

TABLE 1
Factors Influencing Individual DGS

| Category | Factors Influencing Individual DGS |
|---|---|
| Email Management | Frequency of email cleanup. Storage usage |
| | optimization. Management of large attachments. |
| Application | Cleaning up unused cloud resources. Scaling |
| Ownership | applications efficiently. Optimizing data |
| | storage policies. |
| Device Management | Removing redundant software. Optimizing power |
| (Laptop, Mobile, | consumption. Regular system maintenance. |
| Workstation) | |
| Cloud & Storage | Reducing unnecessary backups. Archiving vs. active |
| Usage | storage optimization. Minimizing idle cloud resources. |
| Digital | Deleting obsolete shared files. Reducing duplicate |
| Collaboration Tools | document storage. Efficient use of online |
| | collaboration platforms. |

Table 1 indicates factors for influencing individual DGS. An AI model continuously monitors these areas, assigns scores based on efficiency metrics, and updates the individual's Digital Green Score (DGS) dynamically. According to one embodiment of the invention, the AI Model Workflow includes the following steps:
i) Data Collection: AI monitors digital activities (emails, storage, compute, collaboration).
ii) Behavioral Analysis: Identifies sustainable actions vs. artificial cleanup attempts.
iii) Weight-Based Scoring: Assigns dynamic scores based on verified cleanup impact.
iv) Fraud Prevention Checks: Flags manipulative behaviors and adjusts scoring.
v) Final DGS Calculation: Generates trusted, transparent scores stored on blockchain.

According to one embodiment of the invention, the organizational DGS is an aggregated measure of all individual scores within the entity. The system ensures that:
i) No orphaned resources (unused VMs, idle storage, abandoned applications) exist.
ii) Teams and departments optimize their digital practices.
iii) SG compliance reporting is automatically generated based on blockchain-stored DGS scores.

Further, the organization's sustainability performance is evaluated using a weighted scoring model that considers:
i) Total cloud resource optimization (CPU/GPU utilization, storage efficiency).
ii) Employee digital habits (email cleanup, data retention policies).
iii) Compliance with sustainability goals (measurable impact reduction over time).

According to one embodiment of the invention, To ensure credibility, DGS scores are recorded on a blockchain ledger with the following benefits:
i) Immutable Records: Prevents fraudulent manipulation of sustainability scores.
ii) Third-Party Audits: Organizations can share their DGS with regulatory bodies and sustainability partners.
iii) Smart Contracts for Automated Compliance: Enforces policies such as: Auto-deletion of redundant cloud storage exceeding thresholds and Incentives for sustainable digital behavior (e.g., lower cloud costs for optimized storage use).

The Digital Green Score (DGS) system introduces a novel way to measure, optimize, and enforce environmental responsibility in digital content usage. By leveraging AI for analysis, blockchain for transparency, and smart contracts for automation, this invention provides a scalable and accountable framework for driving sustainable digital practices at both individual and organizational levels.

It will be recognized that the above described subject matter may be embodied in other specific forms without departing from the scope or essential characteristics of the disclosure. Thus, it is understood that, the subject matter is not to be limited by the foregoing illustrative details, but it is rather to be defined by the appended claims.

While specific embodiments of the invention have been shown and described in detail to illustrate the novel and inventive features of the invention, it is understood that the invention may be embodied otherwise without departing from such principles.

What is claimed is:

1. A system for calculating a Digital Green Score (DGS) that evaluates an individual's digital sustainability efforts by aggregating their resource management activities across multiple digital platforms, the system comprising:
artificial intelligence (AI) models to analyze an individual's email management, cloud resource allocation, storage optimization, and compute efficiency to generate a personalized sustainability score.

2. The system as claimed in claim 1, wherein a blockchain-based DGS ledger ensures transparent tracking and auditability of individual and organizational digital sustainability metrics.

3. The system as claimed in claim 1, wherein the system includes a smart contract-based enforcement mechanism that automatically implements sustainability policies and rewards responsible digital behaviour.

4. The system as claimed in claim 1, wherein the system includes a framework for aggregating individual DGS scores at an organizational level to measure overall corporate digital sustainability performance.
